(19) United States
(12) Patent Application Publication
(10) Pub. No.: US 2009/0133029 A1
(43) Pub. Date: May 21, 2009

(54) METHODS AND SYSTEMS FOR TRANSPARENT STATEFUL PREEMPTION OF SOFTWARE SYSTEM

(76) Inventors: Srinidhi VARADARAJAN, Radford, VA (US); Joseph Ruscio, San Francisco, CA (US); Michael Heffner, Blacksburg, VA (US)

Correspondence Address: Arent Fox LLP, 555 West Fifth Street, 48th Floor, Los Angeles, CA, 90013, US

(21) Appl. No.: 12/269,801

(22) Filed: Nov. 12, 2008

Related U.S. Application Data
(60) Provisional application No. 60/987,294, filed on Nov. 12, 2007.

(51) Int. Cl. G06F 9/50

(52) U.S. Cl. 718/104

(57) ABSTRACT

Methods and systems for preemption of software in a computing system that include receiving a preempt request for a process in execution using a set of resources, pausing the execution of the process; and releasing the resources to a shared pool.

### RELATED APPLICATIONS

This application is a non-provisional application claiming benefit under 35 U.S.C. section 119(e) of U.S. Provisional Application Ser. No. 60/987,294, filed Nov. 12, 2007, (titled METHOD FOR TRANSPARENT STATEFUL PREEMPTION OF SOFTWARE SYSTEMS by Varadarajan, et al.), which is hereby incorporated herein by reference.

### BACKGROUND

1. Technical Field

The present invention relates generally to the field of computing. Embodiments of the present invention relate to methods and systems for transparent stateful preemption of software system.

2. Background

One form of computing is distributed computing in which a number of interconnected computing nodes are utilized to solve one or more problems in a coordinated fashion. These nodes may be individual desktop computers, servers, processors or similar machines capable of hosting an individual instance of computation. Each instance of computation or “process” can be implemented as an individual process or a thread of execution inside an operating system process. There has been a significant amount of interest in such distributed systems. This has largely been motivated by the availability of high speed network interconnects that allow distributed systems to reach similar levels of efficiency as those observed by traditional custom supercomputers at a fraction of the cost.

The cooperation between the separate processes in a distributed system can be in form of exchanged messages over an interconnection network or through the accessing and modification of shared memory. Some of the nodes may individually or collectively work on some specific tasks. Certain task may have higher priority than other tasks and there may not be enough resources for all tasks to run concurrently. As such, when needed lower priority tasks may need to release some or all of their resources, so that those resources could be assigned to the higher priority tasks. Efficient transparent mechanisms are desired to assign and revoke resources. Furthermore, the application of such mechanisms should not be limited to distributed systems. The mechanisms should work in various types of computing systems.

### SUMMARY

In one aspect of the disclosure, a method for preemption of software in a computing system comprises receiving a preempt request for a process in execution using a set of resources, pausing the execution of the process, and releasing the resources to a shared pool.

In another aspect of the disclosure, a computer-program product for transparent preemption comprises a machine-readable medium encoded with instructions executable to receive a request to preempt a process in execution using a set of resources, pause the execution of the process, and release the resources to a shared pool.

In yet another aspect of the disclosure, a system for process preemption in a computing organization comprises a communication channel configured to receive a request to preempt a process in execution using a set of resources; and a processor configured to pause the execution of the process and release the resources being used by the process.

In a further aspect of the disclosure, a system for software preemption in a computing organization comprises means for receiving a request for preemption of a process in execution using a set of resources, means for pausing the execution of the process, and means for releasing the resources to a shared pool.

### BRIEF DESCRIPTION OF THE DRAWINGS

Various aspects of the present disclosure are illustrated by way of example, and not by way of limitation, in the accompanying drawings, wherein:

FIG. 1 illustrates an exemplary organization of a distributed computing system.

FIG. 2 illustrates exemplary components of a computing system.

FIG. 3 illustrates a flow diagram for exemplary steps involved in a resource preemption technique.

In accordance with common practice, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the invention are described more fully hereinafter with reference to the accompanying drawings. This invention may, however, be embodied in many different forms and should not be construed as limited to any specific structure or function presented throughout this disclosure. Rather, these aspects are provided so that this disclosure will be thorough and complete, and will fully convey the scope of the invention to those skilled in the art. Based on the teachings herein, one skilled in the art should appreciate that the scope of the invention is intended to cover any aspect of the invention disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect of the invention disclosed herein may be embodied by one or more elements of a claim.

The processing described below may be performed by a computing system which may be a stand alone single or multiple processor computer, or a distributed processing platform. In addition, such processing and functionality can be implemented in the form of special purpose hardware or in the form of software or firmware being run by a general-purpose or network processor. Data handled in such processing or created as a result of such processing can be stored in any type of memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including existing memory technologies as well as hardware or circuit representations of such structures and of such data.

As used herein, the term “distributed system” is intended to include any system which includes two or more components, either computers, machines or other types of processors. Each computer in a distributed system may be, for example, a Symmetric Multiprocessor (SMP) and contain multiple processors. The term “distributed computation” is intended to include any instance of computation that is comprised of two or more processes working in concert to accomplish a computational task. The term “process” as used herein is intended to include any type of program, instruction, code, or the like which runs on one or more computers or other types of processors in a distributed system.

The processes that comprise a distributed computation may cooperate either through the explicit exchange of messages over an interconnection network, the access and modification of memory regions that are shared by all processes, or some combination thereof. In the present embodiment all processes execute concurrently on distinct separate processors and each process will be illustrated as an OS process. The system and method discussed herein is not limited to such an environment however, and may be utilized regardless of the manner in which instances of computation are realized (e.g., user level threads, kernel level threads, and OS process).

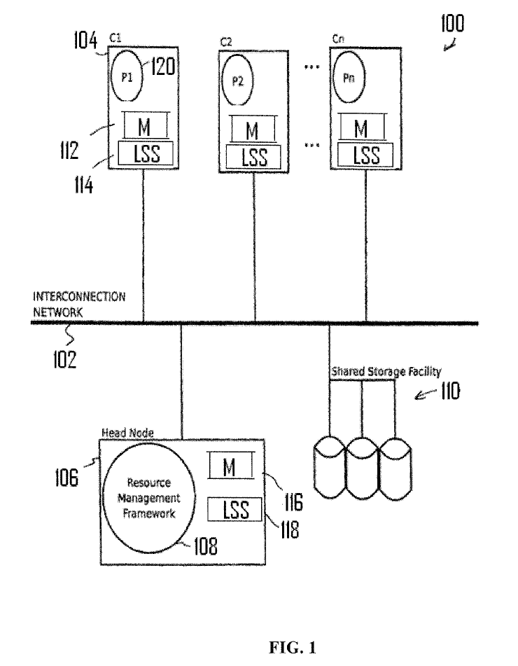

FIG. 1 shows one configuration which is in form of a distributed computing system. The system 100 includes a group of compute nodes 104 (designated as C₁, C₂, . . . , Cₙ) connected through some form of interconnection network 102 to a head node 106 (designated as H) upon which some central resource management software 108 (indicated as resource management framework in FIG. 1) may be executing. Typically, head node 106 is not a compute node. However, in other embodiments, a compute node could be used to serve as the head node.

Interconnection network 102 may be, for example, an Internet-based network. One or more processes 120 may be executed on each compute node 104. For example, a process P₁ may run on compute node C₁, and a process Pₙ, may run on compute node Cₙ. Each process 120 may be executed, for example, by one or more processors. The compute nodes 104 in the system are also connected to a shared secondary storage facility 110. With respect to secondary storage facility 110, the same file system should be visible to any of the compute nodes 104 that are to be migration targets. In a typical embodiment, shared secondary storage facility 110 is accessible by all compute nodes 104.

Each compute node 104 may include local memory 112 (e.g., dynamic RAM), which may be used, for example, to store user-level applications, communications middleware and an operating system, and may also include local secondary storage device 114 (e.g., a hard drive). Local memory 112 may also be used to store messages, or buffer data. Head node 106 may also include local memory 116 and local secondary storage 118. The compute nodes C₁, C₂, . . . , Cₙ, may be computers, workstations, or other types of processors, as well as various combinations thereof.

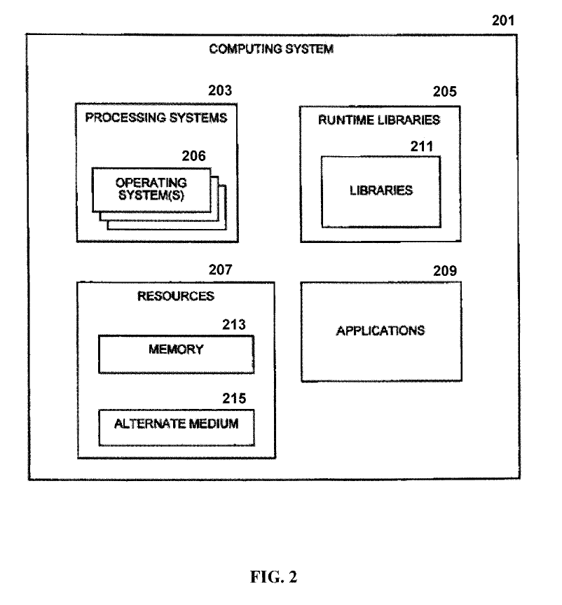

FIG. 2 shows a conceptual configuration of a generic computing system 201 that may be any type of computing system. For example, FIG. 2 can be a conceptual representation of the distributed system 100 of FIG. 1, or it may be a standalone computer. The computing system 201 (which can be a distributed system 100 as shown in FIG. 1) may include one or more processing systems 203 (that could correspond to the compute nodes 104 of FIG. 1), one or more runtime libraries 205 (which may reside in the computing nodes 104 or head node 106 of FIG. 1), a collection of resources 207 (that may include the shared memories 114 or shared storage 110 in FIG. 1), and one or more applications 209 (that may reside in the compute nodes 104, head node 106, or storage facility 110 of FIG. 1). Various types of communication channel may be used to communicate between the components of the computing system 201 (that can be the interconnection network 102 of FIG. 1), including busses, local area networks (LANs), wide area networks (WANs), the Internet or any combination of these. Each of the processing systems 203 may be any type of processing Each of the processing systems 203 may include one or more operating systems 206. Each of the operating systems 206 may be of any type. Each of the operating systems 206 may be configured to perform one or more of the functions that are described herein and other functions.

Each of the applications 209 may be any type of computer application program. Each may be adopted to perform a specific function or to perform a variety of functions. Each may be configured to spawn a large number of processes, some or all of which may run simultaneously. Each process may include multiple threads. As used herein, the term “application” may include a plurality of processes or threads. Examples of applications that spawn multiple processes that may run simultaneously include oil and gas simulations, management of enterprise data storage systems, algorithmic trading, automotive crash simulations, and aerodynamic simulations.

The collection of resources 207 may include resources that one or more of the applications 209 use during execution. The collection of resources 207 may also include resources used by the operating systems 206.

The resources may include a memory 213. The memory 213 may be of any type of memory. Random access memory (RAM) is one example. The memory 213 may include caches that are internal to the processors that may be used in the processing systems 203. The memory 213 may be in a single computer or distributed across many computers at separated locations. For example, the memory 213 also includes an alternate medium 215. The alternate medium 215 may include memory in the form of non-volatile memory such as magnetic disc-based media, including hard drives or other mass storage. The alternate medium 215 includes networked-based mass storage as well.

The resources 207 may include support for inter-process communication (IPC) primitives, such as support for open files, network connections, pipes, message queues, shared memory, and semaphores. The resources 207 may be in a single computer or distributed across multiple computer locations.

The runtime libraries 205 may be configured to be linked to one or more of the applications 209 when the applications 209 are executing. The runtime libraries 205 may be of any type, such as I/O libraries and libraries that perform mathematical computations.

The runtime libraries 205 may include one or more libraries 211. Each of the libraries 211 may be configured to intercept calls for resources from a process that is spawned by an application to which the library may be linked, to allocate resources to the process, and to keep track of the resource allocations that are made. The libraries 211 may be configured to perform other functions, including the other functions described herein.

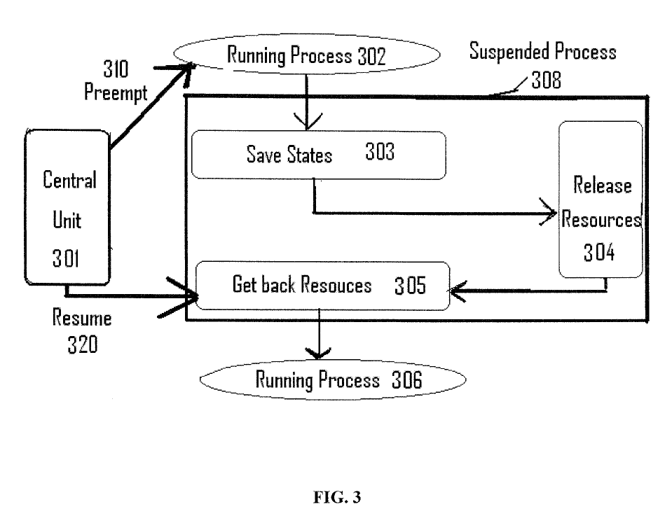

FIG. 3 shows a flow chart illustrating a set of steps involved in one exemplary aspect of disclosure where a run time library is used to handle resource preemption. First, when a preempt instruction 310 is issued by a central unit 301 to a running process 302, the run time library receives the instruction and takes part in issuing instructions to suspend 308 the running process 302. The following steps are performed by the runtime library while the process is suspended 308. First, the run time library issues an instruction so that the states of the process are saved 303 and the resources that were used by the process are released 304, and therefore the released processes can be used by other processes in the system. At a later time, the central unit 301 may issue a resume a command 320 which will be received by the library. As a result of the resume command 320, the library issues instructions that causes resources to be returned 305 to the suspended process, and causes the suspended process to resume and return to running states 306. The steps illustrated above are transparent because they are done as part of a library and as such they require no modifications to existing applications. The above method may be used for handling resource preemption in a manner that may enable the migration of individual processes, and that may be transparent to the application, middleware that is in use, and the operating system

Therefore, referring to FIG. 1 and FIG. 2, when the computing system 201 (or the distributed system 100) is instructed by a job scheduler (e.g. Platform LSF) to preempt a low priority job, the mechanism of FIG. 3 can be employed to free all related system memory and the application license (if applicable). When the computing system 201 (or distributed system 100) is instructed to resume the suspended job, the mechanism of FIG. 3 pulls memory and other required resources back in and the job continues from where it left off. The mechanism ensures that no compute cycles are lost, thereby increasing job throughput while maximizing server utilization.

The mechanism of FIG. 3 can be executed as run time or dynamic library. As such, the dynamic library can be integrated into a software system without any need to modify the software. The integration can be done at the time of execution through any number of standard instrumentation methods. It should be noted that this method could also be implemented at lower levels in the software. The benefits of a runtime library are transparency to the software system as well as the operating system and hypervisor. Lower-level implementations still have the benefit of being transparent to the software system. It can work for serial jobs and parallel jobs which use Message Passing Interface (MPI) for inter process communication.

The mechanism of FIG. 3 has the ability to intercept, record state, and manipulate system calls from the application destined for the operating system as well as handle requests for suspension and resumption The mechanism could use a user level transparent framework to record the state of executing jobs. When one task is to be suspended and another started or resumed in its place, the embodiment described above may be used to save the states the executing computations before halting them.

As such, low priority jobs can be preempted and migrated across nodes as needed without having to deal with any major application or operating system modifications. The mechanism will seamlessly integrate into an existing cluster with minimal configuration, performance overhead and disruption. The mechanism releases specific resources held by that application that experience heavy contention (CPU, memory, network bandwidth, etc.) so that another higher priority application can make use of those resources. After the higher priority application has completed, those resources can be reallocated back to the suspended application allowing it to resume execution.

It is understood that any specific order or hierarchy of steps described above is being presented to provide an example of the processes involved. Based upon design preferences, it is understood that the specific order or hierarchy of steps may be rearranged while remaining within the scope of the invention.

The various components that have been described may be comprised of hardware, software, and/or any combination thereof. For example the libraries 105, the resource management system 108 and the applications 109 may be software computer programs containing computer-readable programming instructions and related data files. These software programs may be stored on storage media, such as one or more floppy disks, CDs, DVDs, tapes, hard disks, PROMS, etc. They may also be stored in RAM, including caches, during execution.

One of more of the above components, including the runtime library may be implemented with one or more general purpose processors. A general purpose processor may be a microprocessor, a controller, a microcontroller, a state machine, or any other circuitry that can execute software. Software shall be construed broadly to mean instructions, data, or any combination thereof, whether referred to as software, firmware, middleware, microcode, hardware description language, or otherwise. Software may be stored on machine-readable media which may include being embedded in one or more components such as a DSP or ASIC. Machine-readable media may include various memory components including, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. Machine-readable media may also be include a transmission line and/or other means for providing software to the computing nodes. The machine readable may be embodied in a computer program product.

Whether the above components are implemented in hardware, software, or a combination thereof will depend upon the particular application and design constraints imposed on the overall system. Skilled artisans may implement the described functionality in varying ways for each particular application, but such implementation decisions should not be interpreted as causing a departure from the scope of the invention.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for preemption of software in a computing system, comprising:
receiving a preempt request for a process in execution using a set of resources;
pausing the execution of the process; and
releasing the resources to a shared pool.

2. The method of claim 1 further comprising receiving a resume instruction, retrieving the resources from the shared pool, and resuming the execution of the paused process using the retrieved resources.

3. The method of claim 1 further comprising receiving a resume instruction, retrieving other resources from the shared pool, and resuming the execution of the paused process using the retrieved resources.

4. The method of claim 1 wherein the execution of the process is paused by saving the states of the process.

5. The method of claim 1 further comprising assigning the resources to another process.

6. The method of claim 1 further comprising intercepting a set of communications between the process and an operating system.

7. The method of claim 6 wherein the interception of the set of communications is transparent to the operating system.

8. The method of claim 6 wherein the interception of the set of communications is transparent to the process.

9. A computer-program product for transparent preemption, comprising:
A machine-readable medium encoded with instructions executable to:
receive a request to preempt a process in execution using a set of resources:
pause the execution of the process; and
release the resources to a shared pool.

10. The computer-program product of claim 9 wherein the machine-readable medium encoded with instructions is further executable to receive a resume instruction, retrieve the resources from the shared pool, and resume the execution of the paused process using the retrieved resources.

11. The computer-program product of claim 9 wherein the machine-readable medium encoded with instructions is further executable to receive a resume instruction, retrieve another set of resources from the shared pool, and resume the execution of the paused process using the retrieved resources.

12. The computer-program product of claim 9 wherein the execution of the process is paused by saving the states of the process.

13. The computer-program product of claim 9 wherein the machine-readable medium encoded with instructions is further executable to assign the resources to another process.

14. The computer-program product of claim 9 wherein the machine-readable medium encoded with instructions is further executable to intercept a set of communications between the process and an operating system.

15. The computer-program product of claim 14 wherein the interception of the set of communications is transparent to the operating system.

16. The computer-program product of claim 14 wherein the interception of the set of communications is transparent to the process.

17. A system for process preemption in a computing organization, comprising:
a communication channel configured to receive a request to preempt a process in execution using a set of resources; and
a processor configured to pause the execution of the process and release the resources being used by the process.

18. The system of claim 17 wherein the communication channel is further configured to receive a resume instruction; and the processor is further configured to retrieve the released resources and resume the execution of the paused process using the retrieved resources.

19. The system of claim 17 wherein the communication channel is further configured to receive a resume instruction; and the processor is further configured to retrieve another set of resources and resume the execution of the paused process using the retrieved resources.

20. The system of claim 17 wherein the execution of the process is paused by saving the states of the process.

21. The system of claim 17 wherein the processor is further configured to assign the resources to another process.

22. The system of claim 17 wherein the processor is further configured to intercept a set of communications between the process and an operating system.

23. The system of claim 22 wherein the interception of the set of communications is transparent to the operating system.

24. The system of claim 22 wherein the interception of the set of communications is transparent to the process.

25. The system of claim 17 further comprising a plurality of computing nodes wherein each computing node is configured to execute at least one process.

26. A system for software preemption in a computing organization, comprising:
means for receiving a request for preemption of a process in execution using a set of resources;
means for pausing the execution of the process; and
means for releasing the resources to a shared pool.

27. The system of claim 26 further comprising means for receiving a resume instruction, means for retrieving the resources from the shared pool, and means for resuming the execution of the paused process using the retrieved resources.
